(19) United States
(12) Patent Application Publication
(10) Pub. No.: US 2023/0354091 A1
(43) Pub. Date: Nov. 2, 2023

(54) NETWORK CONGESTION MITIGATION

(71) Applicant: Meta Platforms Technologies, LLC, Menlo Park, CA (US)

(72) Inventors: Xiaodi Zhang, San Ramon, CA (US); Ping Wang, Redmond, WA (US); Swaminathan Balakrishnan, Los Gatos, CA (US); Jiansong Wang, Lincroft, NJ (US); Achaleshwar Sahai, San Jose, CA (US); Qi Qu, Redmond, WA (US)

(21) Appl. No.: 17/731,191

(22) Filed: Apr. 27, 2022

(51) Int. Cl. H04W 28/02

(52) U.S. Cl. CPC H04W 28/0273; H04W 28/0284; H04W 28/0289

(57) ABSTRACT

Disclosed herein are related to reducing network congestion of wireless communication. In one aspect, a base station of a wireless cellular network determines a level of a network congestion from a plurality of candidate levels of the network congestion. In one aspect, the base station determines whether a type of the network congestion comprises an uplink congestion or a downlink congestion. In one aspect, the base station determines one or more processes to reduce the network congestion, according to the determined level of the network congestion and the determined type of the network congestion. In one aspect, the base station performs the determined one or more processes.

### FIELD OF DISCLOSURE

The present disclosure is generally related to wireless communication, including but not limited to reducing a network congestion of the wireless communication.

### BACKGROUND

Cellular communication technology (e.g., 3G, 4G, 5G) allows high data rate communication. In one example, a user equipment (UE) or an application server (AS) may generate and transmit data to a base station. A base station may provide or forward data from the UE or from the AS to another UE. Alternatively or additionally, a base station may provide or forward data from another base station to another UE. A network between one or more UEs and a base station may be referred to as a radio access network (RAN). Hence, a UE or AS located in one geographical area can communicate with another UE located in another geographical area through one or more RANs.

Often, communication can suffer from network congestions. For example, multiple UEs or ASs may simultaneously attempt to transmit data. However, there is no suitable mechanisms to mitigate or reduce network congestion for low latency communication, in particular, when the network congestion is occurring within a RAN.

### SUMMARY

Various embodiments disclosed herein are related to a base station of a wireless cellular network. In some embodiments, the base station includes at least one processor configured to determine a level of a network congestion from a plurality of candidate levels of the network congestion. In some embodiments, the at least one processor is configured to determine whether a type of the network congestion comprises an uplink congestion or a downlink congestion. In some embodiments, the at least one processor is configured to determine one or more processes to reduce the network congestion, according to the determined level of the network congestion and the determined type of the network congestion. In some embodiments, the at least one processor is configured to perform the determined one or more processes.

In some embodiments, the type of the network congestion comprises the downlink congestion. In some embodiments, the one or more processes include one or more first processes to perform, in response to determining that the level of the downlink congestion is a first level of the downlink congestion above a threshold value. In some embodiments, the one or more processes include one or more second processes to perform, in response to determining that the level of the downlink congestion is a second level of the downlink congestion below the threshold value. In some embodiments, the one or more first processes include at least one of: determining priorities of a set of packets, dropping one or more packets of the set of packets, according to the determined priorities, or releasing one or more radio bearers. In some embodiments, the one or more second processes include at least one of: causing a wireless interface to transmit explicit congestion notification (ECN) to a core network, determining a recommended downlink bit rate, causing the wireless interface to transmit the recommended downlink bit rate to the core network, setting a downlink bearer with an updated quality of service, or starting an active queue management process for a downlink traffic. In some embodiments, the one or more first processes include the one or more second processes (and can include one or more other processes). In some embodiments, the at least one processor is configured to cause the wireless interface to transmit a medium access control control element (MAC CE) notification, in response to the type of the network congestion being the downlink congestion, to a user equipment (UE). In some embodiments, the UE is configured to reduce a duty cycle of monitoring downlink in response to the MAC CE notification.

In some embodiments, the type of the network congestion comprises the uplink congestion. In some embodiments, the one or more processes include: one or more first processes to perform, in response to determining that the level of the uplink congestion is a first level of the uplink congestion above a threshold value, and one or more second processes to perform, in response to determining that the level of the uplink congestion is a second level of the uplink congestion below the threshold value. In some embodiments, the one or more first processes include at least one of: performing a congestion control by allowing a partial uplink traffic, according to quality of service, or releasing one or more radio bearers. In some embodiments, the one or more second processes include at least one of: determining a recommended uplink bit rate, causing a wireless interface to transmit a medium access control control element (MAC CE) notification indicating the recommended uplink bit rate to a user equipment (UE), setting a new uplink bearer with an updated quality of service, or starting an active queue management process for an uplink traffic. In some embodiments, the one or more first processes include the one or more second processes. In some embodiments, the type of the network congestion comprises both the uplink congestion and the downlink congestion.

Various embodiments disclosed herein are related to a method of communication. In some embodiments, the method includes determining, by a base station of a wireless cellular network, a level of a network congestion from a plurality of candidate levels of the network congestion. In some embodiments, the method includes determining, by the base station, whether a type of the network congestion comprises an uplink congestion or a downlink congestion. In some embodiments, the method includes determining, by the base station, one or more processes to reduce the network congestion, according to the determined level of the network congestion and the determined type of the network congestion. In some embodiments, the method includes performing, by the base station, the determined one or more processes.

In some embodiments, the type of the network congestion comprises the downlink congestion. In some embodiments, the one or more processes include one or more first processes to perform, in response to determining that the level of the downlink congestion is a first level of the downlink congestion above a threshold value. In some embodiments, the one or more processes include one or more second processes to perform, in response to determining that the level of the downlink congestion is a second level of the downlink congestion below the threshold value. In some embodiments, the one or more first processes include at least one of: determining, by the base station, priorities of a set of packets, dropping, by the base station, one or more packets of the set of packets, according to the determined priorities, or releasing, by the base station, one or more radio bearers. In some embodiments, the one or more second processes include at least one of: transmitting, by the base station, explicit congestion notification (ECN) to a core network, determining, by the base station, a recommended downlink bit rate, transmitting, by the base station, the recommended downlink bit rate to the core network, setting, by the base station, a new downlink bearer with an updated quality of service, or starting, by the base station, an active queue management process for a downlink traffic. In some embodiments, the one or more first processes include the one or more second processes. In some embodiments, the method includes transmitting, by the base station, a medium access control control element (MAC CE) notification, in response to the type of the network congestion comprising the downlink congestion, to a user equipment (UE). In some embodiments, the UE is configured to reduce a duty cycle of monitoring downlink in response to the MAC CE notification.

In some embodiments, the type of the network congestion comprises the uplink congestion, and the one or more processes include: one or more first processes to perform, in response to determining that the level of the uplink congestion is a first level of the uplink congestion above a threshold value, and one or more second processes to perform, in response to determining that the level of the uplink congestion is a second level of the uplink congestion below the threshold value. In some embodiments, the one or more first processes include at least one of: performing a congestion control by allowing a partial uplink traffic, according to quality of service, or releasing one or more radio bearers. In some embodiments, the one or more second processes include at least one of: determining a recommended uplink bit rate, transmitting, by the base station, a medium access control control element (MAC CE) notification indicating the recommended uplink bit rate to a user equipment (UE), setting a new uplink bearer with an updated quality of service, or starting an active queue management process for an uplink traffic. In some embodiments, the one or more first processes include the one or more second processes.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram showing example components of a base station and a user equipment, according to an example implementation of the present disclosure.

FIG. 3 is a diagram of a network congestion controller, according to an example implementation of the present disclosure.

FIG. 4 is an example IP layer data frame including fields for congestion control, according to an example implementation of the present disclosure.

FIG. 5 is an example of a medium access control control element for congestion control, according to an example implementation of the present disclosure.

FIG. 6 is a flowchart showing a process of reducing or mitigating a network congestion, according to an example implementation of the present disclosure.

FIG. 7 is a flowchart showing a process of reducing downlink congestion, according to an example implementation of the present disclosure.

FIG. 8 is a flowchart showing a process of reducing uplink congestion, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Disclosed herein are related to reducing or mitigating network congestion of a cellular communication (e.g., 3G, 4G, 5G). In one aspect, a base station of a wireless cellular network determines a level of a network congestion from a plurality of candidate levels of the network congestion. In one aspect, the base station determines whether a type of the network congestion comprises an uplink congestion or a downlink congestion. In one aspect, the base station determines one or more processes to reduce the network congestion, according to the determined level of the network congestion and the determined type of the network congestion. In one aspect, the base station performs the determined one or more processes. Advantageously, by selecting or performing different processes according to the level of the network congestion and the type of the network congestion, the network congestion can be adaptively reduced or mitigated through various approaches with granularity.

For example, if the level of a downlink congestion is below a first threshold value (e.g., medium or light downlink congestion), then the base station may i) transmit explicit congestion notification (ECN) to a core network, ii) determine a recommended downlink bit rate and transmit the recommended downlink bit rate to the core network, iii) set a new downlink bearer/flow with an updated quality of service (QoS), iv) start an active queue management (AQM) process for DL traffic, or v) perform any combination of them. For example, if the level of the downlink congestion is above the first threshold value (e.g., heavy downlink congestion), the base station may i) drop one or more packets, according to quality of service priorities, ii) release one or more radio bearers, or iii) perform a combination of them. Additionally, if the level of the downlink congestion is above the first threshold value (e.g., heavy downlink congestion), then the base station may perform one or more processes performed for the medium or light downlink congestion.

For example, if the level of an uplink congestion is below a second threshold value (e.g., medium or light uplink congestion), then the base station may i) determine a recommended uplink bit rate and transmit a medium access control control element (MAC CE) notification indicating the recommended uplink bit rate to a user equipment (UE), ii) set a new uplink bearer/flow with an updated QoS, iii) start an AQM process for UL traffic, or iv) perform any combination of them. For example, if the level of the uplink congestion is above the second threshold value (e.g., heavy uplink congestion), then the base station may i) allow a partial uplink traffic, according to QoS, ii) release one or more radio bearers, iii) set a new uplink bearer/flow with an updated QoS, iv) start an AQM process for UL traffic, or v) perform any combination of them. Additionally, if the level of the uplink congestion is above the second threshold value (e.g., heavy uplink congestion), then the base station may perform one or more processes performed for the medium or light uplink congestion.

In one aspect, the base station may provide a message or notification conforming to a physical layer communication protocol to the UE to resolve a network congestion promptly. For example, for the uplink congestion, the base station may determine a recommended uplink bit rate and transmit a MAC CE notification indicating the recommended uplink bit rate to a UE. In response to the MAC CE notification indicating the recommended uplink bit rate, the UE may adjust the transmit data rate based on the recommended uplink bit rate, and skip or bypass some transmission (e.g., buffer status report (BSR)/status report (SR) transmission) to mitigate or reduce uplink congestion. By providing a notification conforming to a physical layer communication protocol rather than an IP layer communication protocol (e.g., ECN), congestion at the RAN between the base station and the UE can be resolved or mitigated promptly. Hence, communication with low latency and high throughput, for example, for augmented reality or virtual reality, can be provided in a seamless manner with less interference due to network congestion.

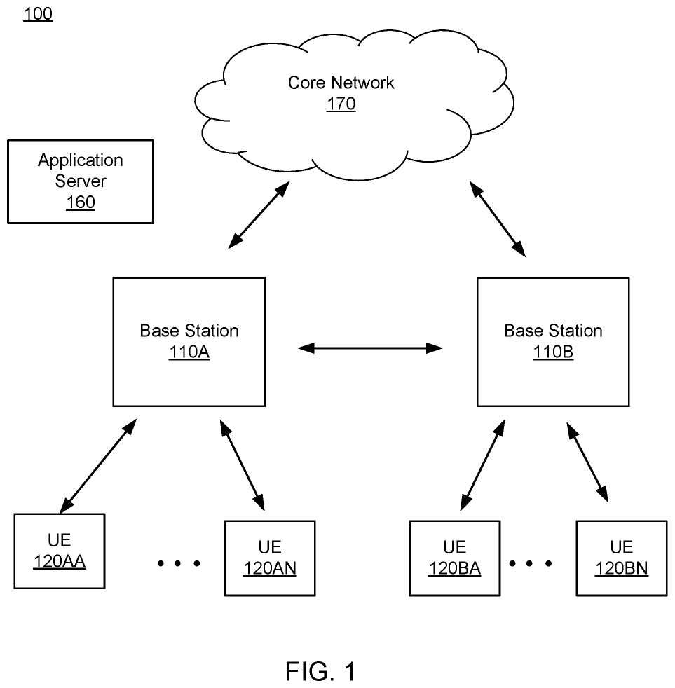

FIG. 1 illustrates an example wireless communication system 100. The wireless communication system 100 may include base stations 110A, 110B (also referred to as “wireless communication nodes 110” or “stations 110”) and user equipments (UEs) 120AA . . . 120AN, 120BA . . . 120BN (also referred to as “wireless communication devices 120” or “terminal devices 120”). The wireless communication link may be a cellular communication link conforming to 3G, 4G, 5G or other cellular communication protocols. In one example, the wireless communication link supports, employs or is based on an orthogonal frequency division multiple access (OFDMA). In one aspect, the UEs 120AA . . . 120AN are located within a geographical boundary with respect to the base station 110A, and may communicate with or through the base station 110A. Similarly, the UEs 120BA . . . 120BN are located within a geographical boundary with respect to the base station 110B, and may communicate with or through the base station 110B. A network between UEs 120 and the base stations 110 may be referred to as radio access network (RAN). In some embodiments, the wireless communication system 100 includes more, fewer, or different number of base stations 110 than shown in FIG. 1.

In some embodiments, the UE 120 may be a user device such as a mobile phone, a smart phone, a personal digital assistant (PDA), tablet, laptop computer, wearable computing device (e.g., head mounted display, smart watch), etc. Each UE 120 may communicate with the base station 110 through a corresponding communication link. For example, the UE 120 may transmit data to a base station 110 through a wireless communication link (e.g., 3G, 4G, 5G or other cellular communication link), and/or receive data from the base station 110 through the wireless communication link (e.g., 3G, 4G, 5G or other cellular communication link). Example data may include audio data, image data, text, etc. Communication or transmission of data by the UE 120 to the base station 110 may be referred to as an uplink communication. Communication or reception of data by the UE 120 from the base station 110 may be referred to as a downlink communication.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations.

In some embodiments, the wireless communication system 100 includes a core network 170. The core network 170 may be a component or an aggregation of multiple components that ensures reliable and secure connectivity to the network for UEs 120. The core network 170 may be communicatively coupled to one or more base stations 110A, 110B through a communication link. A communication link between the core network 170 and a base station 110 may be a wireless communication link (e.g., 3G, 4G, 5G or other cellular communication link) or a wired communication link (e.g., Ethernet, optical communication link, etc.). In some embodiments, the core network 170 includes user plane function (UPF), access and mobility management function (AMF), policy control function (PCF), etc. The UPF may perform packet routing and forwarding, packet inspection, quality of service (QoS) handling, and provide external protocol data unit (PDU) session for interconnecting data network (DN). The AMF may perform registration management, reachability management, connection management, etc. The PCF may help operators (or operating devices) to easily create and seamlessly deploy policies in a wireless network. The core network 170 may include additional components for managing or controlling operations of the wireless network. In one aspect, the core network 170 may receive a message to perform a network congestion control, and perform the requested network congestion control. For example, the core network 170 may receive explicit congestion notification (ECN) from a base station 110 and/or a UE 120, and perform a network congestion control according to the ECN. For example, the core network 170 may adjust or control an amount of data generated, in response to the ECN. Additionally or alternatively, the core network 170 may adjust or control an amount of data transmitted and/or received, in response to the ECN.

In some embodiments, the wireless communication system 100 includes an application server 160. The application server 160 may be a component or a device that generates, manages, or provides content data. The application server 160 may be communicatively coupled to one or more base stations 110A, 110B through a communication link. A communication link between an application server 160 and a base station 110 may be a wireless communication link (e.g., 3G, 4G, 5G or other cellular communication link) or a wired communication link (e.g., Ethernet, optical communication link, etc.). In one aspect, an application server 160 may receive a request for data from a UE 120 through a base station 110, and provide the requested data to the UE 120 through the base station 110. In one aspect, an application server 160 may receive a message to perform a network congestion control, and perform the requested network congestion control. For example, the application server 160 may receive explicit congestion notification (ECN) from a base station 110, a UE 120, or a core network 170, and perform a network congestion control according to the ECN. For example, the application server 160 may adjust or control an amount of data generated, in response to the ECN. Additionally or alternatively, the application server 160 may adjust or control an amount of data transmitted and/or received, in response to the ECN.

In some embodiments, communication among the base stations 110, the UEs 120, application server 160, and the core network 170 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

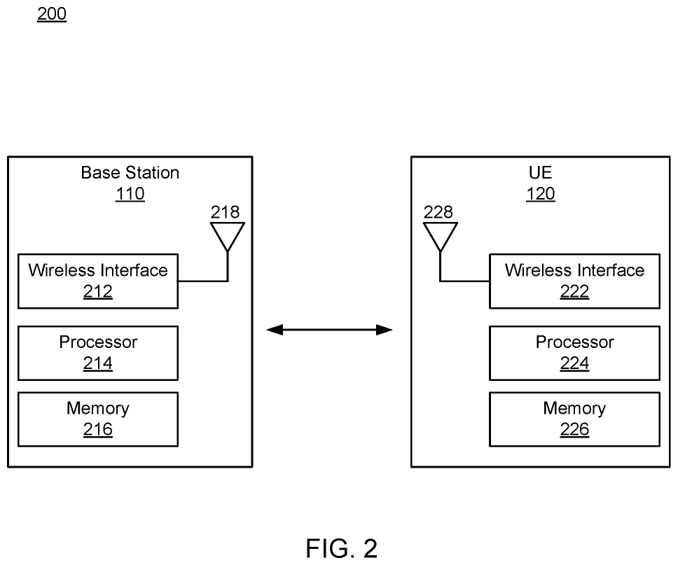

FIG. 2 is a diagram showing example components of a base station 110 and a user equipment 120, according to an example implementation of the present disclosure. In some embodiments, the UE 120 includes a wireless interface 222, a processor 224, a memory device 226, and one or more antennas 228. These components may be embodied as hardware, software, firmware, or a combination thereof. In some embodiments, the UE 120 includes more, fewer, or different components than shown in FIG. 2. For example, the UE 120 may include an electronic display and/or an input device. For example, the UE 120 may include additional antennas 228 and wireless interfaces 222 than shown in FIG. 2.

The antenna 228 may be a component that receives a radio frequency (RF) signal and/or transmits a RF signal through a wireless medium. The RF signal may be at a frequency between 200 MHz to 100 GHz. The RF signal may have packets, symbols, or frames corresponding to data for communication. The antenna 228 may be a dipole antenna, a patch antenna, a ring antenna, or any suitable antenna for wireless communication. In one aspect, a single antenna 228 is utilized for both transmitting a RF signal and receiving a RF signal. In one aspect, different antennas 228 are utilized for transmitting the RF signal and receiving the RF signal. In one aspect, multiple antennas 228 are utilized to support multiple-in, multiple-out (MIMO) communication.

The wireless interface 222 includes or is embodied as a transceiver for transmitting and receiving RF signals through one or more antennas 228. The wireless interface 222 may communicate with a wireless interface 212 of the base station 110 through a wireless communication link. In one configuration, the wireless interface 222 is coupled to one or more antennas 228. In one aspect, the wireless interface 222 may receive the RF signal at the RF frequency received through an antenna 228, and downconvert the RF signal to a baseband frequency (e.g., 0˜1 GHz). The wireless interface 222 may provide the downconverted signal to the processor 224. In one aspect, the wireless interface 222 may receive a baseband signal for transmission at a baseband frequency from the processor 224, and upconvert the baseband signal to generate a RF signal. The wireless interface 222 may transmit the RF signal through the antenna 228.

The processor 224 is a component that processes data. The processor 224 may be embodied as field programmable gate array (FPGA), application specific integrated circuit (ASIC), a logic circuit, etc. The processor 224 may obtain instructions from the memory device 226, and execute the instructions. In one aspect, the processor 224 may receive downconverted data at the baseband frequency from the wireless interface 222, and decode or process the downconverted data. For example, the processor 224 may generate audio data or image data according to the downconverted data, and present an audio indicated by the audio data and/or an image indicated by the image data to a user of the UE 120. In one aspect, the processor 224 may generate or obtain data for transmission at the baseband frequency, and encode or process the data. For example, the processor 224 may encode or process image data or audio data at the baseband frequency, and provide the encoded or processed data to the wireless interface 222 for transmission.

The memory device 226 is a component that stores data. The memory device 226 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 226 may be embodied as a non-transitory computer readable medium storing instructions executable by the processor 224 to perform various functions of the UE 120 disclosed herein. In some embodiments, the memory device 226 and the processor 224 are integrated as a single component.

In some embodiments, the base station 110 includes a wireless interface 212, a processor 214, a memory device 216, and one or more antennas 218. These components may be embodied as hardware, software, firmware, or a combination thereof. In some embodiments, the base station 210 includes more, fewer, or different components than shown in FIG. 2. For example, the base station 210 may include an electronic display and/or an input device. For example, the base station 210 may include additional antennas 218 and wireless interfaces 212 than shown in FIG. 2.

The antenna 218 may be a component that receives a radio frequency (RF) signal and/or transmits a RF signal through a wireless medium. The antenna 218 may be a dipole antenna, a patch antenna, a ring antenna, or any suitable antenna for wireless communication. In one aspect, a single antenna 218 is utilized for both transmitting a RF signal and receiving a RF signal. In one aspect, different antennas 218 are utilized for transmitting the RF signal and receiving the RF signal. In one aspect, multiple antennas 218 are utilized to support multiple-in, multiple-out (MIMO) communication.

The wireless interface 212 includes or is embodied as a transceiver for transmitting and receiving RF signals through one or more antennas 218. The wireless interface 212 may communicate with a wireless interface 222 of the UE 120 through a wireless communication link. In one configuration, the wireless interface 212 is coupled to one or more antennas 218. In one aspect, the wireless interface 212 may receive the RF signal at the RF frequency received through antenna 218, and downconvert the RF signal to a baseband frequency (e.g., 0˜1 GHz). The wireless interface 212 may provide the downconverted signal to the processor 214. In one aspect, the wireless interface 212 may receive a baseband signal for transmission at a baseband frequency from the processor 214, and upconvert the baseband signal to generate a RF signal. The wireless interface 212 may transmit the RF signal through the antenna 218.

The processor 214 is a component that processes data. The processor 214 may be embodied as FPGA, ASIC, a logic circuit, etc. The processor 214 may obtain instructions from the memory device 216, and execute the instructions. In one aspect, the processor 214 may receive downconverted data at the baseband frequency from the wireless interface 212, and decode or process the downconverted data. For example, the processor 214 may generate audio data or image data according to the downconverted data. In one aspect, the processor 214 may generate or obtain data for transmission at the baseband frequency, and encode or process the data. For example, the processor 214 may encode or process image data or audio data at the baseband frequency, and provide the encoded or processed data to the wireless interface 212 for transmission. In one aspect, the processor 214 may set, assign, schedule, or allocate communication resources for different UEs 120. For example, the processor 214 may set different modulation schemes, time slots, channels, frequency bands, etc. for UEs 120 to avoid interference. The processor 214 may generate data (or UL CGs) indicating configuration of communication resources, and provide the data (or UL CGs) to the wireless interface 212 for transmission to the UEs 120.

The memory device 216 is a component that stores data. The memory device 216 may be embodied as RAM, flash memory, ROM, EPROM, EEPROM, registers, a hard disk, a removable disk, a CD-ROM, or any device capable for storing data. The memory device 216 may be embodied as a non-transitory computer readable medium storing instructions executable by the processor 214 to perform various functions of the base station 110 disclosed herein. In some embodiments, the memory device 216 and the processor 214 are integrated as a single component.

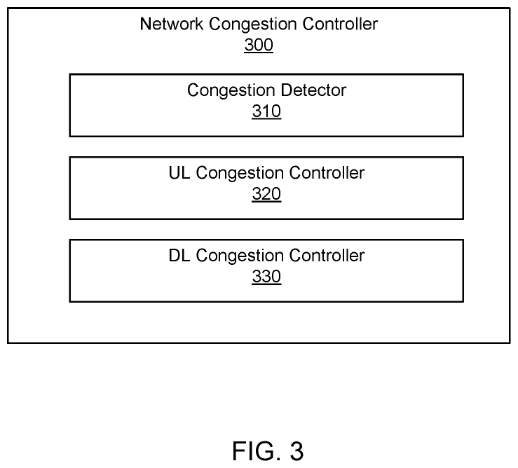

FIG. 3 is a diagram of a network congestion controller 300, according to an example implementation of the present disclosure. The network congestion controller 300 may be embodied as part of the base station 110 and/or any one or more network nodes of a core/cellular network. The network congestion controller 330 may be implemented as FPGA, ASIC, or any logic circuit. The network congestion controller 300 may be implemented as part of the processor 214. In some embodiments, the network congestion controller 300 includes a congestion detector 310, an uplink (UL) congestion controller 320, and a downlink (DL) congestion controller 330. These components may operate together to reduce or mitigate network congestion. In some embodiments, the network congestion controller 300 includes more, fewer, or different components than shown in FIG. 3.

In some embodiments, the congestion detector 310 is a component that detects/monitors/measures a network congestion. In one aspect, the congestion detector 310 detects one or more types of network congestion. Examples of a type of a network congestion can include an uplink congestion, a downlink congestion, a base station node congestion, or any combination of them. The congestion detector 310 may determine the type of the network congestion by determining whether the network congestion occurs for uplink traffic/communication, downlink traffic/communication, or both. In one approach, the congestion detector 310 may monitor a buffer status for transmission/reception to determine the type of the network congestion. For example, in response to a buffer for downlink communication in the wireless interface 212 being full or having data over a threshold amount for a time period, the congestion detector 310 may determine that the type of the network congestion is downlink congestion. For example, the wireless interface 212 can determine, check, or monitor for the number of UL active users, UL SR or BSR, interference and/or physical resource block (PRB) utilization over a time period to determine UL congestion and the corresponding congestion level (light/mid/heavy). In one approach, the congestion detector 310 may monitor an amount of unsuccessful transmissions/receptions to determine the type of the network congestion. For example, in response to a number of unsuccessful uplink communication exceeding a threshold number for a time period across multiple UEs, the congestion detector 310 may determine that the type of the network congestion is uplink congestion. Similarly, in response to a number of unsuccessful downlink communication exceeding a threshold number for a time period across multiple UEs, the congestion detector 310 may determine that the type of the network congestion is downlink congestion. In some embodiments, the congestion detector 310 receives a message indicating a type of network congestion from another device (e.g., UE 120, core network 170, application server 160, or another communication device), and may determine the type of the network congestion as indicated by the received message.

In some embodiments, the congestion detector 310 detects or determines a level of a network congestion. The congestion detector 310 may determine or select a level of the network congestion from a plurality of candidate levels of the network congestion. Examples of the plurality of candidate levels of an uplink congestion can include a heavy level uplink congestion (e.g., first level congestion), a medium level uplink congestion (e.g., second level congestion), a light level uplink congestion (e.g., third level congestion), etc. For example, the heavy level uplink congestion may have an uplink congestion over a first threshold amount; the medium level uplink congestion may have an uplink congestion over a second threshold amount and/or less than the first threshold amount; and the light level uplink congestion may have an uplink congestion less than the second threshold amount, where the first threshold amount is higher than the second threshold amount. Although three levels of an uplink congestion are provided as an example, a different number of levels of the uplink congestion can be provided. Similarly, examples of the plurality of candidate levels of a downlink congestion can include a heavy level downlink congestion, a medium level downlink congestion, a light level downlink congestion, etc. For example, the heavy level downlink congestion may have a downlink congestion over a third threshold amount; the medium level downlink congestion may have a downlink congestion over a fourth threshold amount; and the light level downlink congestion may have a downlink congestion less than the fourth threshold amount, where the third threshold amount is higher than the fourth threshold amount. Although three levels of a downlink congestion are provided as an example, a different number of levels of a downlink congestion can be provided. In one approach, the congestion detector 310 may monitor a buffer status for transmission/reception, and can determine the level of the network congestion corresponding to the buffer status. In one approach, the congestion detector 310 may monitor an amount of unsuccessful transmissions/receptions, and can determine the level of the network congestion corresponding to the amount of unsuccessful transmissions/receptions. In some embodiments, the congestion detector 310 receives a message indicating a level of a network congestion from another device (e.g., UE 120, core network 170, application server 160, or another communication device), and can determine the level of the network congestion as indicated by the received message.

In some embodiments, the UL congestion controller 320 is a component that performs or initiates one or more processes to reduce uplink congestion. In one example, if the level of an uplink congestion is below a threshold value (e.g., medium or light uplink congestion), then UL congestion controller 320 may determine a recommended uplink bit rate and can cause the wireless interface 212 to transmit a MAC CE notification indicating the recommended uplink bit rate to a UE 120. The UE 120 may adjust a data rate for uplink transmission, for example, by skipping or bypassing BSR/SR transmission, or informing an application layer (e.g., of the wireless interface 222 or the processor 224) to adjust the data rate. Additionally or alternatively, if the level of the uplink congestion is below the threshold value (e.g., medium or light uplink congestion), then UL congestion controller 320 may set a new uplink bearer/flow with an updated QoS, or start an AQM process to reduce or mitigate a UL traffic. In one example, if the level of the uplink congestion is above the threshold value (e.g., heavy uplink congestion), then the UL congestion controller 320 may allow a partial uplink traffic, according to QoS priority. Additionally or alternatively, if the level of the uplink congestion is above the threshold value (e.g., heavy uplink congestion), then the UL congestion controller 320 may release one or more radio bearers with a back off timer, such that the UE 120 may not attempt to retry to re-establish the released bearer immediately (or within a time period set by the back off timer). In some embodiments, if the level of the uplink congestion is above the threshold value (e.g., heavy uplink congestion), the UL congestion controller 320 may perform one or more processes for the light or medium uplink congestion described herein.

In one aspect, the UL congestion controller 320 may generate a message or notification conforming to a physical layer communication protocol to resolve a network congestion, and can cause the wireless interface 212 to transmit the message or notification to the UE 120. For example, for the uplink congestion, the UL congestion controller 320 may determine a recommended uplink bit rate and can generate a MAC CE notification/signaling indicating the recommended uplink bit rate. The UL congestion controller 320 may cause the wireless interface 212 to transmit the MAC CE notification to the UE 120. In response to the MAC CE notification indicating the recommended uplink bit rate, the UE 120 may skip or bypass transmission (e.g., buffer status report (BSR)/status report (SR) transmission) or inform an application layer (e.g., of the wireless interface 222 or the processor 224) to adjust the data rate. By providing a notification conforming to a physical layer communication protocol rather than an IP layer communication protocol (e.g., ECN), congestion at the RAN between the base station 110 and the UE 120 can be reduced, resolved or mitigated promptly. Hence, communication(s) with low latency and high throughput, for example, for augmented reality or virtual reality, can be provided in a seamless manner with less interference due to network congestion.

In some embodiments, the DL traffic controller 330 is a component that performs or initiates one or more processes to reduce downlink congestion. In one example, if the level of a downlink congestion is below a threshold value (e.g., medium or light downlink congestion), then the DL traffic controller 330 may cause the wireless interface 212 to transmit explicit congestion notification (ECN) to the core network 170. Additionally or alternatively, if the level of the downlink congestion is below the threshold value (e.g., medium or light downlink congestion), then the DL traffic controller 330 may determine a recommended downlink bit rate and can cause the wireless interface 212 to transmit the recommended downlink bit rate to the core network 170, such that the core network 170 may perform data rate adjustment or traffic shaping according to the recommended downlink bit rate. Alternatively or additionally, if the level of the downlink congestion is below the threshold value (e.g., medium or light downlink congestion), then the DL traffic controller 330 may set a new downlink bearer/flow with an updated QoS, or start an AQM process to reduce or mitigate a DL traffic. In one example, if the level of the downlink congestion is above the threshold value (e.g., heavy downlink congestion), the DL traffic controller 330 may drop one or more packets, according to QoS priorities. Additionally or alternatively, if the level of the downlink congestion is above the threshold value (e.g., heavy downlink congestion), the DL traffic controller 330 may release one or more radio bearers with a back off timer indication. In some embodiments, if the level of the downlink congestion is above the threshold value (e.g., heavy downlink congestion), the DL congestion controller 330 may also perform one or more processes for the light or medium downlink congestion described herein.

In some embodiments, the DL traffic controller 330 may generate a physical layer message or notification and can cause the wireless interface 212 to transmit such physical layer message or notification. For example, the DL traffic controller 330 may cause the wireless interface 212 to generate a MAC CE notification to cause the UE 120 to set or configure connected mode discontinuous reception (CDRX) setting, and can cause the wireless interface 212 to transmit the MAC CE notification to the UE 120. In response to receiving the MAC CE notification, the UE 120 may set or configure the CDRX setting to reduce a duty cycle to monitor for downlink. By reducing the duty cycle to monitor for the downlink, the UE 120 may reduce power consumption. Moreover, by providing a notification conforming to a physical layer communication protocol rather than an IP layer communication protocol (e.g., ECN), the UE 120 can adjust its configuration in a prompt manner.

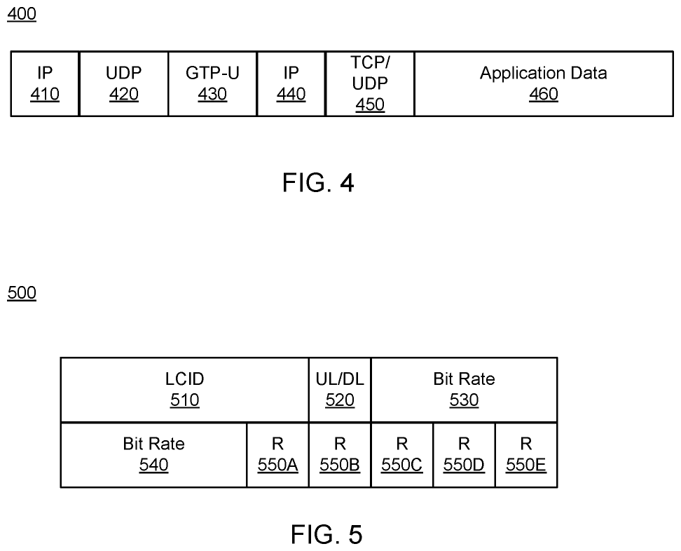

FIG. 4 is an example IP layer data frame 400 including fields for congestion control, according to an example implementation of the present disclosure. In some embodiments, the data frame 400 includes fields 410, 420, 430, 440, 450, and 460. The IP layer data frame 400 may be provided by a base station 110. For example, the IP layer data frame 400 may be provided for ECN. In some embodiments, the IP layer data frame 400 may be also provided by a UE 120, an application server 160, a core network 170, or any communication device.

In one aspect, the fields 410-430 may be general packet radio service tunneling protocol user plane (GTP-U) tunnel header information. In some embodiments, one or more bits or data for congestion control can be provided in the field 410. The field 410 may be/include an IP header (field) including ECN bits (e.g., two bits) in differentiated services code point (DSCP) for GTP-U tunnel network congestion control. The field 420 may be/include a user datagram protocol (UDP) field and the field 430 may be a GTP-U field. In some embodiments, according to the ECN bits in the field 410, the core network 170 and/or the application server 160 may perform network congestion control. For example, ‘01’ or ‘10’ of the ECN bits in the field 410 may indicate a sender of the data frame 400 is capable of ECN. For example, ‘00’ of the ECN bits in the field 410 may indicate the sender of the data frame 400 is not using ECN. For example, ‘11’ of the ECN bits in the field 410 may indicate whether a network congestion is detected. In response to receiving ‘11’ in the ECN bits, the core network 170 and/or the application server 160 may initiate a process to reduce network congestion, for example, by performing traffic shaping, reducing downlink data rate, etc.

In one aspect, the fields 440-460 may be application IP packet. In some embodiments, one or more bits or data for congestion control can be provided in any one of the fields 440-450. The field 440 may be IP header including ECN bits (e.g., two bits) for application layer network congestion control. The field 450 may be a transmission control protocol (TCP)/UDP field. The field 460 may be a field including application data. In some embodiments, according to the ECN bits in the field 440, the core network 170 and/or the application server 160 may perform network congestion control in a similar manner as described above with respect to the ECN bits in the field 410.

FIG. 5 is an example a MAC CE 500 for congestion control, according to an example implementation of the present disclosure. In some embodiments, the MAC CE 500 includes fields 510-540 and 550A-550E. The MAC CE 500 may be provided/sent by a base station 110. For example, the MAC CE 500 may be provided to cause, trigger, or initiate network congestion control.

The field 510 may include or indicate a logical channel identifier (LCD) for which the recommended bit rate or the recommend bit rate query is applicable. The field 520 may include or indicate whether the recommended bit rate or the recommended bit rate query applies to uplink or downlink. For example, ‘0’ may indicate a downlink, and ‘1’ may indicate an uplink (or vice versa). The fields 530, 540 may include or indicate the recommended bit rate. The fields 550A-550E may be reserved fields.

In one aspect, the reserved fields 550A-550E may be utilized/re-purposed/configured to perform, trigger, initiate or cause a network congestion control. Each reserved field 550 may have one bit. In one approach, two bits (or two of the reserve fields 550) may be utilized to indicate a level of network congestion. For example, ‘00’ may indicate no network congestion detected, ‘01’ or ‘10’ may indicate light/medium RAN congestion detected, and ‘11’ may indicate heavy RAN congestion detected. The base station 110 may utilize the fields 530, 540, and the two bits of the reserved fields 550A-550E to notify the UE 120 the current RAN network congestion direction and the level of network congestion. For example, for light/mid RAN congestion, the base station 110 may send the field 520 indicating the uplink congestion, UL bit rate recommendation in the field 530, 540 and ‘01’ in the reserved field 550 to inform or cause the UE 120 to adjust UL traffic bit rate to mitigate RAN network congestion.

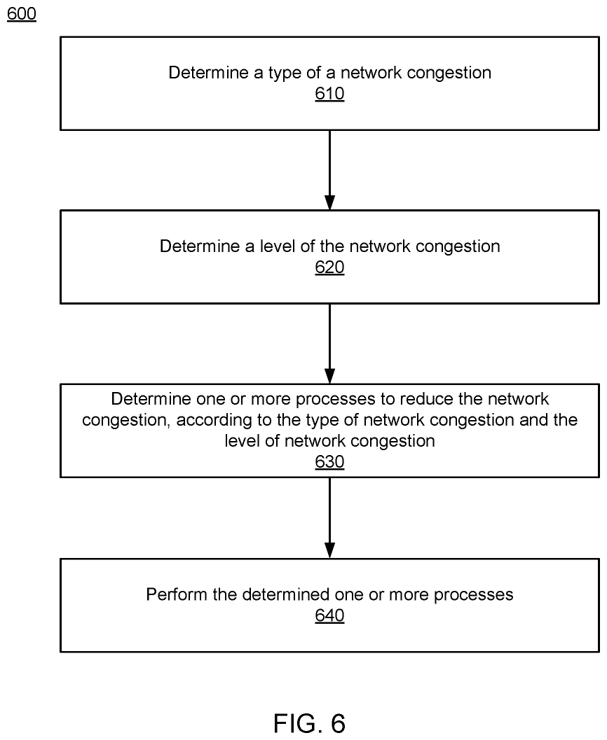

FIG. 6 is a flowchart showing a process 600 of reducing network congestion, according to an example implementation of the present disclosure. In some embodiments, the process 600 is performed by the base station 110. In some embodiments, the process 600 is performed by other entities. In some embodiments, the process 600 includes more, fewer, or different steps than shown in FIG. 6.

In one approach, the base station 110 determines 610 a type of a network congestion. Examples of a type of a network congestion include an uplink congestion, a downlink congestion, or both. The congestion detector 310 may determine the type (e.g., direction) of the network congestion by determining whether the network congestion occurs for uplink, downlink, or both. In one approach, the base station 110 may monitor a buffer status for transmission/reception to determine the type of the network congestion. In one approach, the base station 110 may monitor an amount (e.g., level, extent) of unsuccessful transmissions/receptions to determine the type of the network congestion. In some embodiments, the base station 110 receives a message indicating a type of a network congestion from another device (e.g., UE 120, core network 170, application server 160, or another communication device), and determines the type of the network congestion as indicated by the received message.

In one approach, the base station 110 determines 620 a level (e.g., amount, range, extent) of the network congestion. The base station 110 may determine or select, from a plurality of candidate levels of the network congestion, a level of the network congestion. Examples of the plurality of candidate levels of an uplink congestion can include a heavy level uplink congestion, a medium level uplink congestion, a light level uplink congestion, etc. Similarly, examples of the plurality of candidate levels of a downlink congestion can include a heavy level downlink congestion, a medium level downlink congestion, a light level downlink congestion, etc. In one approach, the base station 110 may monitor a buffer status for transmission/reception, and can determine the level of the network congestion corresponding to the buffer status. In one approach, the base station 110 may monitor an amount of unsuccessful transmissions/receptions for a time period, and determine the level of the network congestion corresponding to the amount of unsuccessful transmissions/receptions. In some embodiments, the base station 110 receives a message indicating a level of a network congestion from another device (e.g., UE 120, core network 170, application server 160, or another communication device), and can determine the level of the network congestion as indicated by the received message.

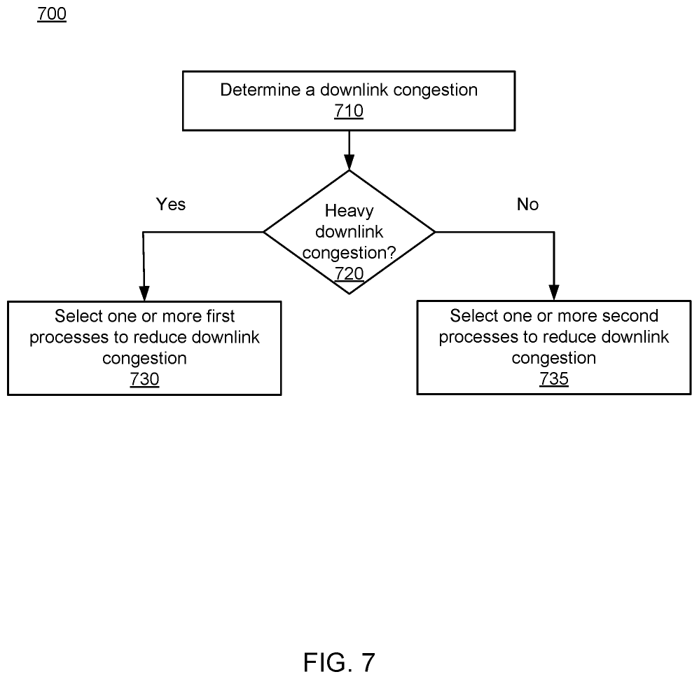

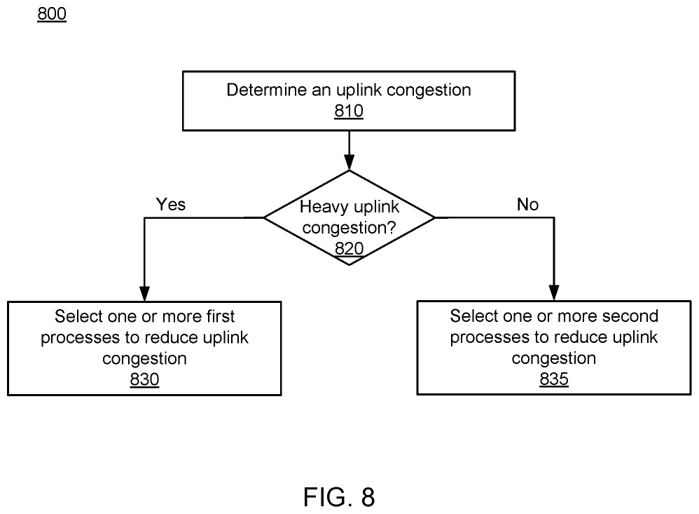

In one approach, the base station 110 determines 630 one or more processes to reduce the network congestion, according to the determined type of the network congestion and the determined level of the network congestion. For example, if the determined type of network congestion is a downlink congestion, the base station 110 may select, from a set of processes to reduce downlink congestion, one or more processes, according to the level of a downlink congestion. Examples of determining or selecting one or more processes to reduce the downlink congestion according to the level of the downlink congestion are provided below with respect to FIG. 7. For example, if the determined type of network congestion is an uplink congestion, the base station 110 may select, from a set of processes to reduce uplink congestion, one or more processes, according to the level of the uplink congestion. Examples of determining or selecting one or more processes to reduce the uplink congestion according to the level of the uplink congestion are provided below with respect to FIG. 8. If the determined type of network congestion is both uplink congestion and downlink congestion, then the base station 110 may select, from a set of processes to reduce the uplink congestion, one or more processes, according to the level of the uplink congestion, and can select, from a set of processes to reduce the downlink congestion, one or more processes, according to the level of the downlink congestion.

In one approach, the base station 110 performs 640 the determined one or more processes.

FIG. 7 is a flowchart showing a process 700 of reducing downlink congestion, according to an example implementation of the present disclosure. In some embodiments, the process 700 is performed by the base station 110. In some embodiments, the process 700 is performed by other entities. In some embodiments, the process 700 is performed as part of the steps 610, 620, 630 of FIG. 7. In some embodiments, the process 700 includes more, fewer, or different steps than shown in FIG. 7.

In one approach, the base station 110 determines 710 the type of the network congestion is a downlink congestion from the step 610. For example, in response to a buffer for downlink communication being full or having data over a threshold amount for a time period, the congestion detector 310 may determine the type of the network congestion is the downlink congestion. For example, in response to a number of unsuccessful downlink communication exceeding a threshold number for a time period, the congestion detector 310 may determine the type of the network congestion is the downlink congestion.

In one approach, the base station 110 determines 720 whether the level of the downlink congestion is a heavy downlink congestion or a light/medium downlink congestion. For example, the heavy level downlink congestion may have a downlink congestion over a threshold amount, where the light/medium level downlink congestion may have a downlink congestion less than the threshold amount.

In one approach, in response to the base station 110 determining that the level of the downlink congestion is the heavy downlink congestion, the base station 110 may select 730 one or more first processes to reduce the downlink congestion. The one or more first processes to reduce the downlink congestion may include at least one of: determining priorities of a set of packets, dropping one or more packets of the set of packets, according to the determined priorities, or releasing one or more radio bearers with a back off timer indication. The one or more first processes to reduce the downlink congestion may also include at least one of: transmitting ECN to the core network 170, determining a recommended downlink bit rate, transmitting the recommended downlink bit rate to the core network 170, setting new downlink bearer/flow with an updated QoS, or starting an AQM process to reduce or mitigate DL traffic.

In one approach, in response to the base station 110 determining that the level of the downlink congestion is the light/medium downlink congestion, the base station 110 may select 735 one or more second processes to reduce the downlink congestion. The one or more second processes to reduce the downlink congestion may include at least one of: transmitting ECN to the core network 170, determining a recommended downlink bit rate, transmitting the recommended downlink bit rate to the core network 170, setting a new downlink bearer/flow with an updated QoS, or starting an AQM process to reduce or mitigate DL traffic. Hence, the one or more first processes to reduce the downlink congestion may include the one or more second processes to reduce the downlink congestion.

In one approach, the one or more first processes and/or the one or more second processes may include transmitting a MAC CE notification to a UE 120. In response to the MAC CE notification, the UE 120 may reduce a duty cycle of monitoring downlink. By reducing the duty cycle to monitor for the downlink, the UE 120 may reduce power consumption. Moreover, by providing a notification conforming to a physical layer communication protocol rather than an IP layer communication protocol (e.g., ECN), the UE 120 can adjust its configuration in a prompt manner.

FIG. 8 is a flowchart showing a process 800 of reducing uplink congestion, according to an example implementation of the present disclosure. In some embodiments, the process 800 is performed by the base station 110. In some embodiments, the process 800 is performed as part of the steps 610, 620, 630 of FIG. 8. In some embodiments, the process 800 is performed by other entities. In some embodiments, the process 800 includes more, fewer, or different steps than shown in FIG. 8.

In one approach, the base station 110 determines 810 the type of the network congestion is an uplink congestion from the step 610. For example, in response to a buffer for uplink communication being full or having data over a threshold amount for a time period, the congestion detector 310 may determine the type of the network congestion is the uplink congestion. For example, in response to a number of unsuccessful uplink communication exceeding a threshold number for a time period, the congestion detector 310 may determine the type of the network congestion is the uplink congestion.

In one approach, the base station 110 determines 820 whether the level of the uplink congestion is a heavy uplink congestion or a light/medium uplink congestion. For example, the heavy level uplink congestion may have an uplink congestion over a threshold amount, where the light/medium level uplink congestion may have an uplink congestion less than the threshold amount. In some embodiments, to determine whether the type of network congestion is an uplink congestion and the corresponding congestion level (light/mid/heavy), the base station 110 may determine, check, or monitor for the number of UL active users, UL SR or BSR, and interference/PRB utilization over a time period.

In one approach, in response to the base station 110 determining that the level of the uplink congestion is the heavy uplink congestion, the base station 110 may select/initiate/implement 830 one or more processes to reduce the uplink congestion. The one or more first processes to reduce the uplink congestion may include at least one of: performing a congestion control by allowing a partial uplink traffic, according to quality of service, or releasing one or more radio bearers. The one or more first processes to reduce/suppress/mitigate the uplink congestion may also include at least one of: determining a recommended uplink bit rate, transmitting a MAC CE notification indicating the recommended uplink bit rate to a user equipment (UE), or setting a new uplink bearer/flow with an updated QoS, or starting the AQM process to reduce or mitigate a UL traffic.

In one approach, in response to the base station 110 determining that the level of the uplink congestion is the light/medium uplink congestion, the base station 110 may select 835 one or more second processes to reduce the uplink congestion. The one or more second processes to reduce the uplink congestion may also include at least one of: determining a recommended uplink bit rate, transmitting a MAC CE notification indicating the recommended uplink bit rate to a user equipment (UE), setting a new uplink bearer/flow with an updated QoS, or starting the AQM process to reduce or mitigate a UL traffic. Hence, the one or more first processes to reduce the uplink congestion may include the one or more second processes to reduce the uplink congestion.

In one aspect, providing MAC CE notification can help reduce or mitigate network congestion in a prompt manner. For example, in response to the MAC CE notification indicating the recommended uplink bit rate, the UE 120 may skip or bypass transmission (e.g., buffer status report (BSR)/status report (SR) transmission) or inform an application layer (e.g., of the wireless interface 222 or the processor 224) to reduce the UL transmission data rate. By providing a notification conforming to a physical layer communication protocol rather than an IP layer communication protocol (e.g., ECN), congestion at the RAN between the base station 110 and the UE 120 can be resolved or mitigated promptly. Hence, communication with low latency and high throughput, for example, for augmented reality or virtual reality, can be provided in a seamless manner with less interference due to network congestion.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A base station of a wireless cellular network, comprising:
at least one processor configured to:
determine a level of a network congestion from a plurality of candidate levels of the network congestion,
determine whether a type of the network congestion comprises an uplink congestion or a downlink congestion,
determine one or more processes to reduce the network congestion, according to the determined level of the network congestion and the determined type of the network congestion, and
perform the determined one or more processes.

2. The base station of claim 1, wherein the type of the network congestion comprises the downlink congestion, and the one or more processes include:
one or more first processes to perform, in response to determining that the level of the downlink congestion is a first level of the downlink congestion above a threshold value, and
one or more second processes to perform, in response to determining that the level of the downlink congestion is a second level of the downlink congestion below the threshold value.

3. The base station of claim 2, wherein the one or more first processes include at least one of:
determining priorities of a set of packets,
dropping one or more packets of the set of packets, according to the determined priorities, or
releasing one or more radio bearers.

4. The base station of claim 3, wherein the one or more second processes include at least one of:
causing a wireless interface to transmit explicit congestion notification (ECN) to a core network,
determining a recommended downlink bit rate,
causing the wireless interface to transmit the recommended downlink bit rate to the core network,
setting a downlink bearer with an updated quality of service, or
starting an active queue management process for a downlink traffic.

5. The base station of claim 4, wherein the one or more first processes include the one or more second processes.

6. The base station of claim 5, wherein the at least one processor is configured to cause the wireless interface to transmit a medium access control control element (MAC CE) notification, in response to the type of the network congestion being the downlink congestion, to a user equipment (UE), wherein the UE is configured to reduce a duty cycle of monitoring downlink in response to the MAC CE notification.

7. The base station of claim 1, wherein the type of the network congestion comprises the uplink congestion, and the one or more processes include:
one or more first processes to perform, in response to determining that the level of the uplink congestion is a first level of the uplink congestion above a threshold value, and
one or more second processes to perform, in response to determining that the level of the uplink congestion is a second level of the uplink congestion below the threshold value.

8. The base station of claim 7, wherein the one or more first processes include at least one of:
performing a congestion control by allowing a partial uplink traffic, according to quality of service, or
releasing one or more radio bearers.

9. The base station of claim 8, wherein the one or more second processes include at least one of:
determining a recommended uplink bit rate,
causing a wireless interface to transmit a medium access control control element (MAC CE) notification indicating the recommended uplink bit rate to a user equipment (UE),
setting a new uplink bearer with an updated quality of service, or
starting an active queue management process for an uplink traffic.

10. The base station of claim 9, wherein the one or more first processes include the one or more second processes.

11. The base station of claim 1, wherein the type of the network congestion comprises both the uplink congestion and the downlink congestion.

12. A method comprising:
determining, by a base station of a wireless cellular network, a level of a network congestion from a plurality of candidate levels of the network congestion;
determining, by the base station, whether a type of the network congestion comprises an uplink congestion or a downlink congestion;
determining, by the base station, one or more processes to reduce the network congestion, according to the determined level of the network congestion and the determined type of the network congestion; and
performing, by the base station, the determined one or more processes.

13. The method of claim 12, wherein the type of the network congestion comprises the downlink congestion, and the one or more processes include:
one or more first processes to perform, in response to determining that the level of the downlink congestion is a first level of the downlink congestion above a threshold value, and
one or more second processes to perform, in response to determining that the level of the downlink congestion is a second level of the downlink congestion below the threshold value.

14. The method of claim 13, wherein the one or more first processes include at least one of:
determining, by the base station, priorities of a set of packets,
dropping, by the base station, one or more packets of the set of packets, according to the determined priorities, or
releasing, by the base station, one or more radio bearers.

15. The method of claim 14, wherein the one or more second processes include at least one of:
transmitting, by the base station, explicit congestion notification (ECN) to a core network,
determining, by the base station, a recommended downlink bit rate,
transmitting, by the base station, the recommended downlink bit rate to the core network,
setting, by the base station, a new downlink bearer with an updated quality of service, or
starting, by the base station, an active queue management process for a downlink traffic.

16. The method of claim 15, wherein the one or more first processes include the one or more second processes.

17. The method of claim 16, further comprising:
transmitting, by the base station, a medium access control control element (MAC CE) notification, in response to the type of the network congestion comprising the downlink congestion, to a user equipment (UE), wherein the UE is configured to reduce a duty cycle of monitoring downlink in response to the MAC CE notification.

18. The method of claim 12, wherein the type of the network congestion comprises the uplink congestion, and the one or more processes include:
one or more first processes to perform, in response to determining that the level of the uplink congestion is a first level of the uplink congestion above a threshold value, and
one or more second processes to perform, in response to determining that the level of the uplink congestion is a second level of the uplink congestion below the threshold value.

19. The method of claim 18, wherein the one or more first processes include at least one of:
performing a congestion control by allowing a partial uplink traffic, according to quality of service, or
releasing one or more radio bearers, and
wherein the one or more second processes include at least one of:
determining a recommended uplink bit rate,
transmitting, by the base station, a medium access control control element (MAC CE) notification indicating the recommended uplink bit rate to a user equipment (UE),
setting a new uplink bearer with an updated quality of service, or
starting an active queue management process for an uplink traffic.

20. The method of claim 19, wherein the one or more first processes include the one or more second processes.
